(19) United States
(12) Patent Application Publication
(10) Pub. No.: US 2002/0170442 A1
(43) Pub. Date: Nov. 21, 2002

(54) Device and process for the automatic supplying of a processing station with sausages

(76) Inventor: Uli Fessmann, Winnenden (DE)

Correspondence Address: Stephan A. Pendorf, Pendorf & Cutliff, P. O. Box 20445, Tampa, FL, 33622-0445, US

(21) Appl. No.: 10/151,643

(22) Filed: May 20, 2002

(30) Foreign Application Priority Data
May 19, 2001 (DE) 101 24 719.2

(51) Int. Cl. A23L 1/00

(52) U.S. Cl. 99/485

(57) ABSTRACT

The invention concerns a device and a process for automatic feeding of a treatment facility with sausages (12) with a release station (10) continuously providing sausages (12) and a conveyor device (18) for transporting the sausages (12) from the release station (10) to a feed station (20). For an automated operation with high through-put, it is proposed that the conveyor device (18) includes a number of conveyor bands (16) branching via at least one branch point (14) for the provision of parallel sausage columns (56) to the feed station (20).

### BACKGROUND OF THE INVENTION

1. Field of the Invention

The invention concerns a device and a process for the automatic supplying or provisioning of a processing station with sausages or the like charge or feed materials, in which a release station continuously provides sausages and a conveyor device transports the sausages from the release station to a feed station.

2. Description of the Related Art

In the manufacture of sausage products it is known from U.S. Pat. No. 5,354,230 to hang sausages in the form of joined sausage strings over smoke sticks on hook devices of a chain conveyor and to transfer these to a subsequent processing station for example for cooking, smoking and cooling. It is considered to be a disadvantage therein, that the sausages must be prepared in the string form and transported, which incurs besides the high labor investment also difficulties during the transfer between individual conveyors.

### SUMMARY OF THE INVENTION

Beginning therewith it is the task of the present invention to supply sausages or other consumer goods automatically with high through-put and substantially without interruption to a treatment station.

For the solution to this task there is proposed a device and a process for automatic feeding of a treatment facility with sausages (12) with a release station (10) continuously providing sausages (12) and a conveyor device (18) for transporting the sausages (12) from the release station (10) to a feed station (20). For an automated operation with high through-put, it is proposed that the conveyor device (18) includes a number of conveyor bands (16) branching via at least one branch point (14) for the provision of parallel sausage columns (56) to the feed station (20).

The task is solved with respect to the apparatus therein, that the conveyor device includes a plurality of conveyor bands branching via at least one distribution branch or switch point or diverter for the parallel provisioning of sausage columns at the feed station. As a result of the branching it is possible to divide or fragment a continuous conveyor material stream into individual strands or, as the case may be, columns, and subsequently to prepare these in parallel conveyor branches, so that sufficient transition time is provided in order to supply a treatment station and, in particular, a basket conveyor.

According to one particularly preferred embodiment of the invention at least one conveyor band includes at least one band segment which transitions from a flat cross-section into a V-shaped cross section band segment in a central area for orienting or directing the sausages in the transport direction. Thereby, those errors in directional distribution or alignment during feeding-in or distributing the material being conveyed are reliably prevented, which during further transfer result in a disruption of the entire facility, in that diagonally oriented sausages are imparted a force for orientation in a transport direction on the basis of the changing conveyor band geometry. This can be preferably achieved thereby, that at least one conveyor band includes an upper leader or strand between the V-shaped middle segment and flat end segments, said upper leader or strand varying in its flank pitch or rise or inclination or taper. A further improvement is achieved thereby, that at least one conveyor band formed as the centering band includes two band bands running parallel, guided horizontally over a segment and preferably in a central segment tilted V-shaped relative to each other.

A particularly high through-put can be achieved when the conveyor bands connect the depository station with the supply station in the manner of a tree or branch structure with multiple transition or delivery points.

In order to make possible a transport with as little damage as possible, it is of advantage when the distribution branches include a blow jet acted upon by compressed air and oriented transverse to the transport direction of the entering sausages, for transferring sausages between two further conveying conveyor bands. In order to act upon the sausages with compressed air over the largest possible effect or area, it is advantageous, when the blow jets have a longitudinal emission slit oriented for blowing against the longitudinal surface of the entering sausages.

In order to have a substantially problem-free direction-changing by means of the blow jets, it is advantageous, when air directing sheet metal is provided on the distribution branches for redirecting compressed air between a blowing direction oriented transverse to the transport direction of the sausage and a blowing direction running in the transport direction.

Preferably the sausages are selectively distributable via the distribution branches from an incoming conveyor band onto either a continuous conveyor band or a branching-off conveyor band. Therein the deviating conveyor band can exhibit a vertical band for directing or guiding the detoured sausages sideways, in order to provide for a quieting-down of the stream of goods. A further advantageous embodiment envisions that the continuous conveyor band includes a band start segment which lies flat and is preferably higher than the branching-off conveyor band.

The band geometry can be simply adapted in that the conveyor bands respectively exhibit two individual bands running next to each other with sideways separation.

Basically it is also possible, for the directing of the conveyed goods in the transport direction, that the individual bands are driven with transport speeds which are different from each other.

In order to make possible an automated operation, it is advantageous to provide a light barrier or light shutter which can be tripped by sausages transported upon one of the conveyor bands. Therein it is advantageous when, prior to the distribution branching points, and in certain cases at the end of the further conveying conveyor band, respectively one light barrier is provided which can be triggered by the there-through passing sausages, and when the distribution branches are controllable by means of a control unit depending upon the output signals of the light barriers.

In order to control the distribution of the sausages into columns, a counter is connected downstream of the light barrier for determination of a predetermined number of sausages transported in a row. Alternatively, it is possible to determine a predetermined column length of sausages transported in a row, and to employ a timing mechanism trigerable by the light barriers.

It is advantageous in the case of a disturbance and in particular in the case of a jam in a conveyor branch to have a blow-out station for the sideways discharging of sausages from the concerned conveyor using compressed air.

For influencing the length of the column and for controlling the deflection, in particular for an optimal supplying of conveyor baskets, it is advantageous when the opposing distances and/or the transfer duration of the sequential transported sausages are adjustable via a conveyor band which, as a buffer band, is changeable in its transport speed.

Advantageously, in the area of the supply station, there are arranged conveyor bands which can be braked to a standstill for readying respectively individual sausage columns preferably parallel to each other. Thereby the sausage columns can respectively be transferred through one associated transfer unit to abasket conveyor running through the processing facility.

A further advantageous embodiment envisions that the transfer movement of the transfer unit is controllable via a drive device, in particular control signals taken from a chain drive of the basket conveyor. Thereby the synchronization is simplified and, in particular, registry errors on the basis of a possible movement tolerance of the individual conveyor baskets is avoided.

A further improvement is achieved thereby, that the sausage columns can respectively be bumped by a pusher or bumper from a conveyor band sideways into conveyor baskets guided thereby, and that the bumper pushers are moveable back and forth by means of an electro-motor driven eccentric drive.

In respect to the process, the task of the invention is solved thereby, that the sausages are subdivided via a plurality of branching band conveyors over at least one distribution branch and column-wise are furnished at the supply station.

A further variation of the invention envisions that the sausages during the transport are oriented or directed in the transport direction by passing through conveyor band sections varying in flank pitch and forming a trough or cradle shaped conveyor band.

### BRIEF DESCRIPTION OF THE DRAWING

In the following the invention will be described in greater detail on the basis of the illustrative embodiment shown in schematic manner in the drawings. There is shown

FIG. 1 an arrangement for automatic supplying a processing station with sausages in side view;

FIG. 2 two branching conveyor bands of the device according to FIG. 1 in an enlarged side view;

FIG. 3 a branch point according to FIG. 2 with branch off point in top view;

FIG. 4 a branch point in cross-section perpendicular to the transport direction;

FIG. 5 a V-shaped central segment of a conveyor band in cross-sections;

FIGS. 6 through 8 a supply station for supplying conveyor baskets passing through the processing facility in side view, top view and a vertical section.

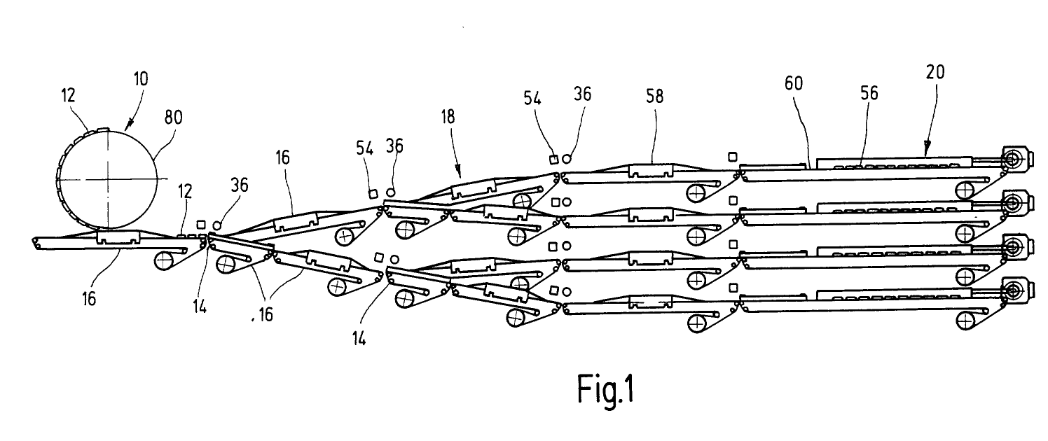

### DETAILED DESCRIPTION OF THE INVENTION

The arrangement illustrated in the drawing makes possible the supplying of a continuously working processing facility in particular for cooking, smoking and cooling of sausages. It is comprised essentially of a deposit or release station 10 for sausages 12 and a conveyor device 18 comprising multiple conveyor bands 16 branching over distribution branch points 14 for the column-wise transport of the sausages from the release station to a supply or feeding installation 20. The conveyor bands 16 thereby connect the feed station 10 with formation of a tree or branchlike branched conveyor band structure with multiple transfer points to the feed station 20.

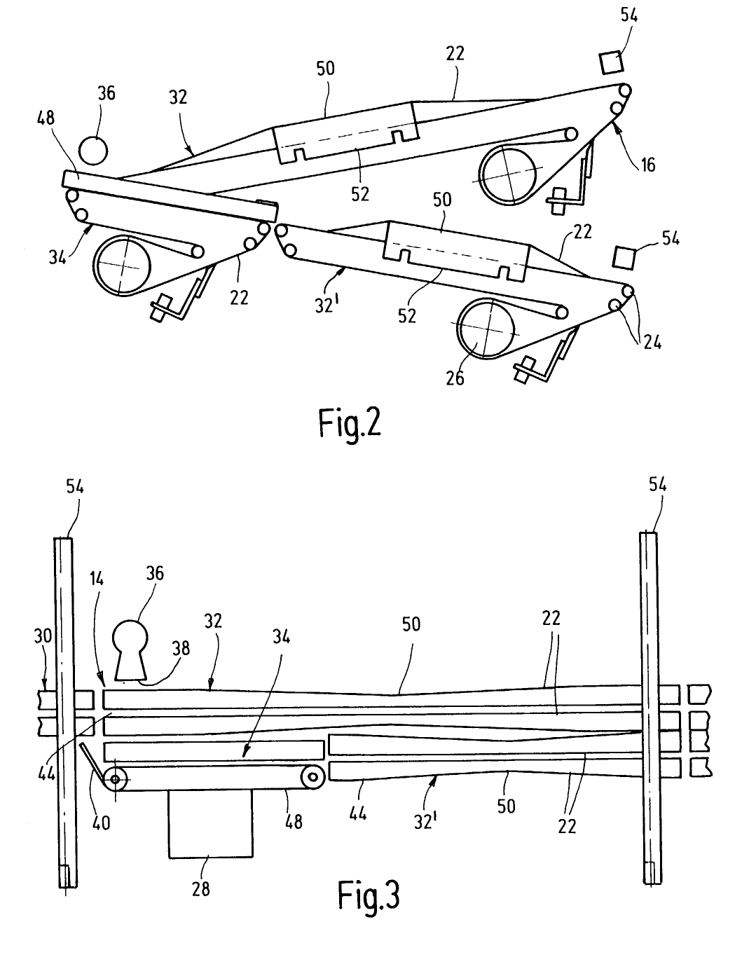

As can best be seen from FIGS. 2 and 3, the conveyor bands 16 respectively comprise two individual bands 22, which are driven by means of motor 28 to cycle spaced apart sideways from each other over redirection rollers 24 and drive rollers 26 in a not shown band framework. The sausages 12 are distributed via the distribution branch points 14 from an inlet or feed band conveyor 30 selectively to an aligned continuous conveyor band 32 or a (sideways) deviating or as the case may be branched off band conveyor 34. For this purpose, at the branch points 14 there are respectively provided blow jets 36 acted upon by high pressure, which are oriented horizontally transverse to the transport direction of the sausages 12. In order to form a high pressure impulse, the blow jets 36 are provided with a longitudinally extending flat outlet slit 38 acting against the longitudinal side of the incoming sausages 12.

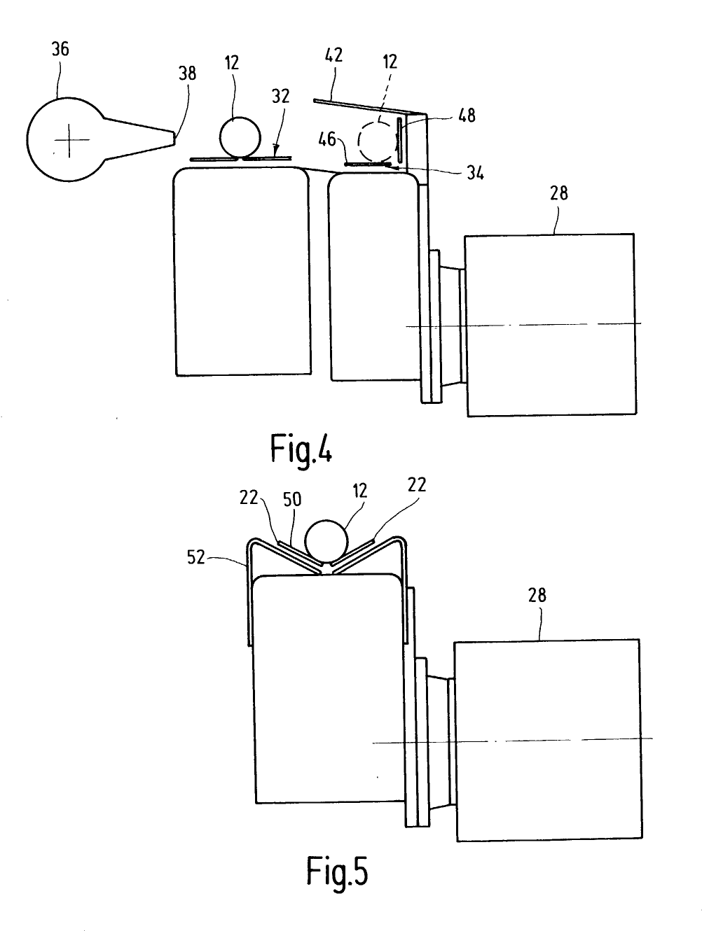

The blow jets 36 are provided on the side beside the through-going conveyor band 32 and blow transverse over this band start-segment towards the branching off conveyor bands 34. The latter are provided with a diagonally oriented impingement sheet metal 40 and a flow redirecting sheet metal 42 tilted slightly from the horizontal and forming a covering, in order to redirect the air stream in the transport direction (FIGS. 3, 4). For the reliable transmission of the sausages 12 the band start point 44 of the through going conveyor band 32 is oriented flat and lies higher than the horizontal band 34 of the branching off conveyor band 34. A further improvement is achieved thereby, that the branching off conveyor band 34 includes a vertical band 48 guiding the redirected sausages 12 sideways.

As can particularly be seen from FIG. 5, for centering the sausages 12 in the therefore provided conveyor bands 16 a V-shaped center segment 50 is formed by the individual bands 22 guided over a cradle-shaped support framework 52. By the varying flank pitch beginning from the flat band start 44, diagonal sausages 12 are given an impulse, which leads to a centering in the band center and orientation in the transport direction. Such centering bands are provided in the deposit station 10 and also all branches, whereby the through-going conveyor band 32 and a further conveyor 32′, connected to the branching conveyor band 34 are appropriately designed.

In order to control the transport process and particularly the distribution points 14, light barriers or shutters 54 which can be triggered by the passing transported sausages 12 are provided at the end areas of the conveyor bands 16, of which the output signals are supplied to a not-shown control unit or, as the case may be, control computer. Therewith it is also possible, besides controlling deviation or detours, in the case of a jam or tie-up, to activate a not shown blow-off station for the sideways blowing off of the sausages 12 from a conveyor band 16. This can occur above all my means of the recognition of a jam or tie-up by light barriers 54, so that the transport over the not impacted (tied-up) conveyor paths can continue to be maintained active.

For forming of sausage columns 56 the control computer includes a counter mechanism, which after determining a predetermined number of sausages 12 transported past the light barrier 54 in sequence, causes redirection at an appropriate redirection point 14. Alternative to this, it is also possible to determine the length of a sausage column 56 by a timer started by a light barrier 54, wherein after passage of a time interval likewise a distribution branch point 14 is switched.

In order to be able to change the spacing of the sausages 12 transported in columns, in each conveyor branch a conveyor band 16 is provided as a buffer band 58, which can be operated with differing or variable transport speed.

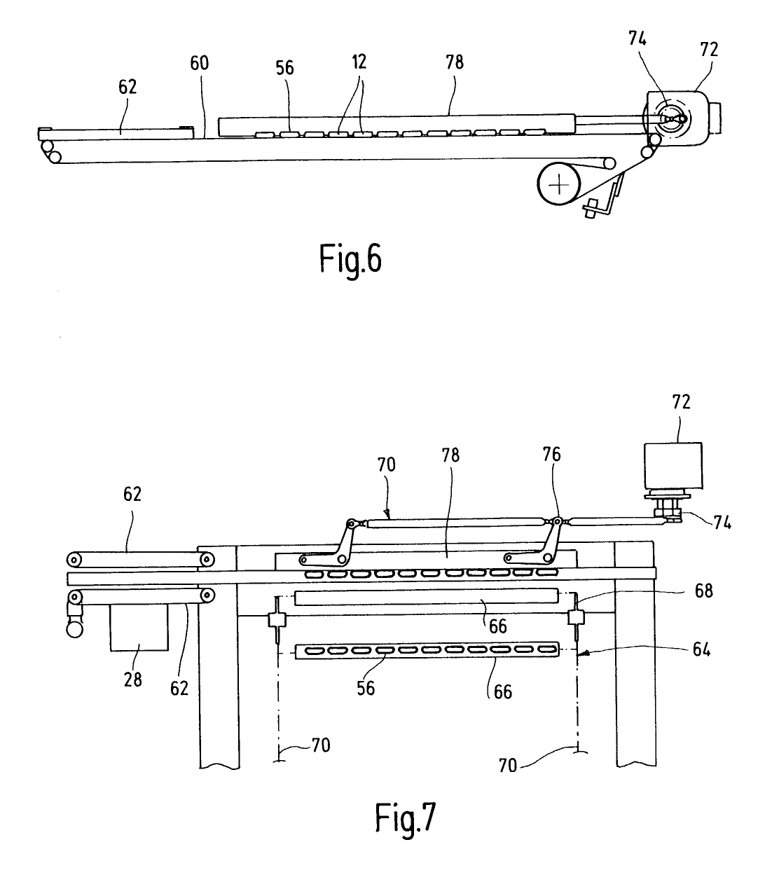

Connected to the buffer band 58 there is provided, downstream from each buffer band 58, in the area of the feed station 20, conveyor bands which can be braked until they stand still as transfer conveyors 60. In order to guarantee a secure or reliable in-feed to this area, the starting segment is respectively flanked by two bands 62 running about vertical redirection rollers (FIGS. 6, 7).

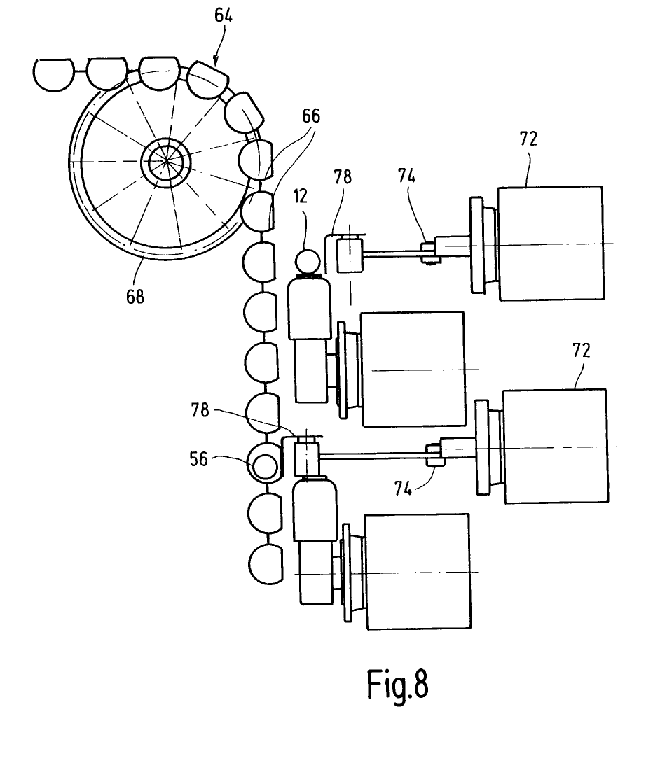

The transfer conveyors 60 oriented parallel to each other define thus the transfer points at which the sausage columns prepared in a not shown processing facility are brought to a continuous basket conveyor 64. As can be seen from FIGS. 7 and 8, the basket conveyor 64 includes a number of longitudinally extending conveyor baskets 66 which are C-shaped in cross-section, which at their ends are carried parallel to each other via conveyor chains 70 guided on chain wheels 68.

At each transfer conveyor 60 one transfer unit 70 is provided, which essentially is comprised of an eccentric drive 74 driven by an electric motor 72 and a bumper or pusher 78 coupled therewith and going back and forth via a knuckle lever rod 76.

During the operation of the above described conveyor system sausage strands extruded at the release station 10 are divided at a cutting wheel 80 and the thus formed individual sausages 12 are continuously deposited in a row upon a first conveyor band 16. At the subsequent branch point 14 there occurs then by appropriate redirection or deflection a column-wise distribution of the sausages 12, of which the column length is again halved at the second branching in the respective conveyor branch. Any misdirection or mis-orientation of the sausages 12 at the transfer points of the conveyor bands 16 are corrected by the V-shaped band segment 50 in the course of the further transport. The synchronization of the transfer of the simultaneously conveyed prepared sausage columns 56 can occur thereby, that the motor 72 of the driver 72, 74 of the pusher 78 is driven depending upon control signals which are taken from the chain drive 68, 70 by means of suitable detection elements.

Essentially the inventive conveyor system is also employable by the processing of other piece-meal consumables such for example poultry.

What is claimed is:

1. Device for automated provisioning of a treatment facility with sausages (12) or the like feed materials, with a predetermined continuously processing release station (10) for sausages (12) and a conveyor device (18) for transport of the sausages (12) from the release station (10) to a feed station (20), thereby characterized, that the conveyor device (18) includes a number of conveyor bands (16) branching via at least one branching point (15) for providing parallel sausage columns (56) at the feed station (20).

2. Device according to claim 1, thereby characterized, that at least one conveyor band (16) for orientation of the sausages (12) in the transport direction includes a band segment (50) with a central area which transitions from a flat to a V-shaped cross-section.

3. Device according to claim 1 or 2, thereby characterized, that at least one conveyor band (16) includes a cradle which varies the flank pitch between a V-shaped central segment (50) and flat starting and end sections (44).

4. Device according to one of claims 1 through 3, thereby characterized, that at least one conveyor band (16) in the form of a center band includes two parallel running, section-wise horizontally guided bands (22) preferably tilted V-shaped relative to each other in a central segment (50).

5. Device according to one of claims 1 through 4, thereby characterized, that the conveyor bands (16) connect the release station (10) with the feed station (20) in the manner of a branching structure, including a plurality of transition points.

6. Device according to one of claims 1 through 5, thereby characterized, that the branch points (14) include a blow nozzle supplied with compressed air oriented perpendicular to the transport direction of the fed-in sausages (12) for transferring of sausages (12) between two further conveying conveyor bands (16).

7. Device according to claim 6, thereby characterized, that the blow jets (36) have outlet slits (38) oriented longitudinally against the longitudinal sides of the fed-in sausages (12).

8. Device according to one of claims 1 through 7, thereby characterized, that at the distribution points (14) air deflecting sheet metal pieces (40, 42) are provided for deflection of pressurized air between a blow-in direction oriented perpendicular to the direction of transport of the sausages (12) and a blow exit direction oriented in the transport direction.

9. Device according to one of claims 1 through 8, thereby characterized, that the sausages (12) are selectively distributed via the distribution point(s) (14) from an inlet conveyor band (30) to either a continuing-through conveyor band (32) or a branching-off conveyor band (34).

10. Device according to claim 9, thereby characterized, that the branching-off conveyor band (34) includes a vertical band (48) for the guiding of the sides of the detoured or deflected sausages (12).

11. Device according to claim 9 or 10, thereby characterized, that the continuing-through conveyor band (16) includes a flat oriented band start segment which is preferably higher than the branching-off conveyor band (16).

12. Device according to one of claims 1 through 11, thereby characterized, that the conveyor bands (16) respectively include two individual bands (22) spaced apart and running sideways next to each other.

13. Device according to claim 12, thereby characterized, that the individual bands (22) are driveable with different transport speeds relative to each other.

14. Device according to one of claims 1 through 13, characterized by at least one light shutter or barrier (54) triggered by the sausages (12) transported along the conveyor band (16).

15. Device according to one of claims 1 through 14, thereby characterized, that one light barrier (54) adapted to be triggered by the sausages (12) passing by it is provided at the branch points (14) and optionally at the ends of the further conveying conveyor bands (16), respectively.

16. Device according to claim 14 or 15, thereby characterized, that the branch points (14) are controllable via a control unit depending upon the output signals of the light barriers (54).

17. Device according to one of claims 14 through 16, characterized by a counter arranged downstream of the light barriers (54) for determining the passage of a predetermined number of sausages (12) transported in a row.

18. Device according to one of claims 14 through 16, characterized by a timer triggered by the sausages (12) passing through the light barrier (54) for determining a predetermined column length of sausages (12) transported in a row.

19. Device according to one of claims 1 through 18, characterized by at least one blow-out station for the sideways discharge of sausages (12) from a conveyor band (16) by means of air pressure.

20. Device according to one of claims 1 through 19, thereby characterized, that the spacing relative to each other of the sequentially following transported sausages (12) is adjustable via a conveyor (16) as buffer band (58) which is variable in its transport speed.

21. Device according to one of claims 1 through 20, thereby characterized, that in the area of the feed station (20) conveyor bands (60) which can be braked to a still-stand are provided preferably parallel to each other for providing respectively one sausage column (56).

22. Device according to one of claims 1 through 21, thereby characterized, that the sausage columns (56) are respectively transferable via an associated transfer unit (70) to a basket conveyor (64) running through the treatment facility.

23. Device according to claim 22, thereby characterized, that the transfer movement of the transfer units (70) is controlled by a drive device, in particular by control signals derived from a chain drive (68, 70) of the basket conveyor (64).

24. Device according to one of claims 1 through 23, thereby characterized, that the sausage columns (56) can be bumped off via at least one bump pusher (78) from a conveyor band (16) sideways into passing-by conveyor baskets (66).

25. Device according to claim 24, thereby characterized, that the pushers (78) are driven to move back and forth via an electric motor (72) driven eccentric drive (74, 76).

26. Process for automatic feeding of a treatment facility with sausages (12) or the like feed material, wherein sausages (12) preferably continuously supplied at a release station (10) are transported to a feed station (20) by means of a conveyor device (18), thereby characterized, that the sausages (12) are distributed over a number of conveyor bands (16) branching via at least one branch point (14) into sausage columns (56) and are column-wise made available to the feed station (20).

27. Process for automatic feeding of a treatment facility with sausages (12) or the like feed material, wherein sausages (12) preferably continuously supplied at a release station (10) are transported to a feed station (20) by means of a conveyor device (18), thereby characterized, that the sausages (12) during transporting are oriented in the transport direction by a sectionally varying flank pitch change of at least one cradled band conveyor (16) of the conveyor device (18).
